(19) United States
(12) Patent Application Publication
(10) Pub. No.: US 2013/0269228 A1
(43) Pub. Date: Oct. 17, 2013

(54) SAFETY SIGNS

(71) Applicants: Eric E. Larsen, Auburn, MI (US); George F. Loesel, Bay City, MI (US)

(72) Inventors: Eric E. Larsen, Auburn, MI (US); George F. Loesel, Bay City, MI (US)

(73) Assignee: George F. Loesel

(21) Appl. No.: 13/445,303

(22) Filed: Apr. 12, 2012

(51) Int. Cl. G09F 7/00

(52) U.S. Cl. 40/584

(57) ABSTRACT

Magnetic signs having non-magnetic hinges and insert capability.

### BACKGROUND OF THE INVENTION

Signs in the modern age are pretty commonplace. There are signs for almost every use, including, but not limited to, safety signs, traffic signs, directional signs, room signs, chemical safety signs, symbols, and the like.

In everyday activity, we need to have these signs for a variety of reasons, for example, household chores, errands, jobs, etc. and now have come to depend on signs to support our daily life with less stress.

One important aspect of signs is their use in buildings to give directions, indicate particular rooms, determine exits and entrances, and the like. Most important are the signs that can indicate safety concerns, for example, signs that indicate the location of a fire extinguisher and the like.

Another aspect of safety signs, especially in establishments that house senior residents, hospitals, hotels, and the like, is a series of signs that direct fire personnel, or ambulance personal, or police, in efforts to secure the safety of such residents.

It would be most helpful if such signs were more specific with regard to safety, are easy to construct and use, and had the durability to last a long time in service.

What is disclosed and claimed herein are magnetic signs having non-magnetic hinges and insert capability.

### THE INVENTION

Thus, what is disclosed and claimed herein in one embodiment is a non-insert magnetic sign. The sign comprises a first base plate having a bottom edge and a front surface and a second base plate having a top edge and a front surface, wherein the first base plate and the second base plate each have a magnetic coating on the front surface.

There is a hinge connecting the first base plate and second base plate, the hinge being attached to the back surface at the bottom edge of the first base plate and attached to the front surface at the top edge of the second base plate.

The front surface of each base plate has at least one attachment, the attachment being selected from the group consisting essentially of letters, numbers, symbols, and, any combination of letters, numbers, and symbols.

In an additional embodiment, there is a magnetic sign having insert capability. The sign comprises a first base plate having a bottom edge and a front surface and a second base plate having a top edge and a front surface, wherein the first base plate and the second base plate each have a magnetic coating on the front surface.

There is a hinge connecting the first base plate and second base plate, the hinge being attached to the back surface at the bottom edge of the first base plate and attached to the front surface at the top edge of the second base plate. The front surface of each base plate has at least one capability for an insert.

In yet another embodiment, there is a magnetic sign, wherein the sign comprises a base plate, the base plate having a front surface, a top portion, and a bottom portion, and a magnetic coating on the front surface.

The magnetic coating has at least one magnetic attachment attached to it and the magnetic attachment is selected from the group consisting essentially of letters, numbers, symbols, and any combination of letters, numbers, and symbols.

Still, there is another embodiment, which is a non-magnetic sign that requires that the first base plate and the second base plate are held together at the top, thereof, using a fastener, such as, for example, clips, snaps, or locks.

Thus, there is a non-insert sign. The sign comprises a first base plate having a bottom edge and a front surface and a second base plate having a top edge and a front surface.

There is a hinge connecting the first base plate and second base plate, the hinge being attached to the back surface at the bottom edge of the first base plate and being attached to the front surface at the top edge of the second base plate.

The front surface of each base plate has at least one attachment, the attachment being selected from the group consisting essentially of letters, numbers, symbols, and, any combination of letters, numbers, symbols, and combinations of letters, numbers, and symbols. There is a fastener for fastening the second base plate closed over the first base plate.

### BRIEF DESCRIPTION OF THE DRAWINGS

FIG. 1 is a full, partially exploded side view of a sign of this invention in a folded configuration.

FIG. 2 is a full front view of the sign of FIG. 1 in a folded configuration.

FIG. 3 is a full front view of the sign of FIG. 2 in an opened configuration.

FIG. 4 is a full front view of a sign of this invention in a folded configuration.

FIG. 5 is a full front view of the sign of FIG. 4 in an open configuration.

FIG. 6 is a full front view of a sign of this invention in a folded configuration.

FIG. 7 is a full front view of the sign of FIG. 6 in an open configuration.

FIG. 8 is an alternative message of another open configuration of the sign of FIG. 6.

FIG. 9 is a full front view of a sign of this invention showing a “ready” insert.

FIG. 10 is a full front view of a sign of this invention showing a partial insertion of a “locked out” insert into a an insertable pocket.

FIG. 11 is a full front view of the sign of FIG. 10 showing the “locked out” insert fully inserted in the insertable pocket.

FIG. 12 is a full front view of the sign of FIG. 11 in a fully opened configuration.

FIG. 13 is a full front view of a sign of this invention in which the opening is from side to side rather than from top to bottom.

FIG. 14 is a full side view of a sign of this invention showing a vandal cover on the first base plate covering the indicia.

FIG. 15 is a full side view of a sign of this invention showing a vandal cover on both of the first base plate and the second plate covering the indicia surface.

FIG. 16 is a full front view of a highway sign of this invention in a closed configuration.

FIG. 17 is a full front view of the sign of FIG. 16 in an open configuration.

FIG. 18 is a full side view of the sign of FIG. 17 showing a fastener for the second base plate to the first base plate.

### DETAILED DESCRIPTION OF THE INVENTION

Turning now to the invention, and with reference to FIG. 1, there is shown a partially exploded side view of a sign 1 of this invention in which there is shown a wall 9 (not part of the invention), a backer plate 2, a first base plate 3, a second base plate 4, and a magnetic coating 13 on the first base plate 3, as well as a magnetic coating 14 on the second base plate 4.

There is also shown a hinge 6, Braille indicia 7 on the back surface 15 of the second base plate 4, printed indicia, such as letters, numbers and symbols 8, also on the back surface 15 of the second base plate 4, and secondary indicia 10 and 11 on the front surface 16 of the first base plate 3.

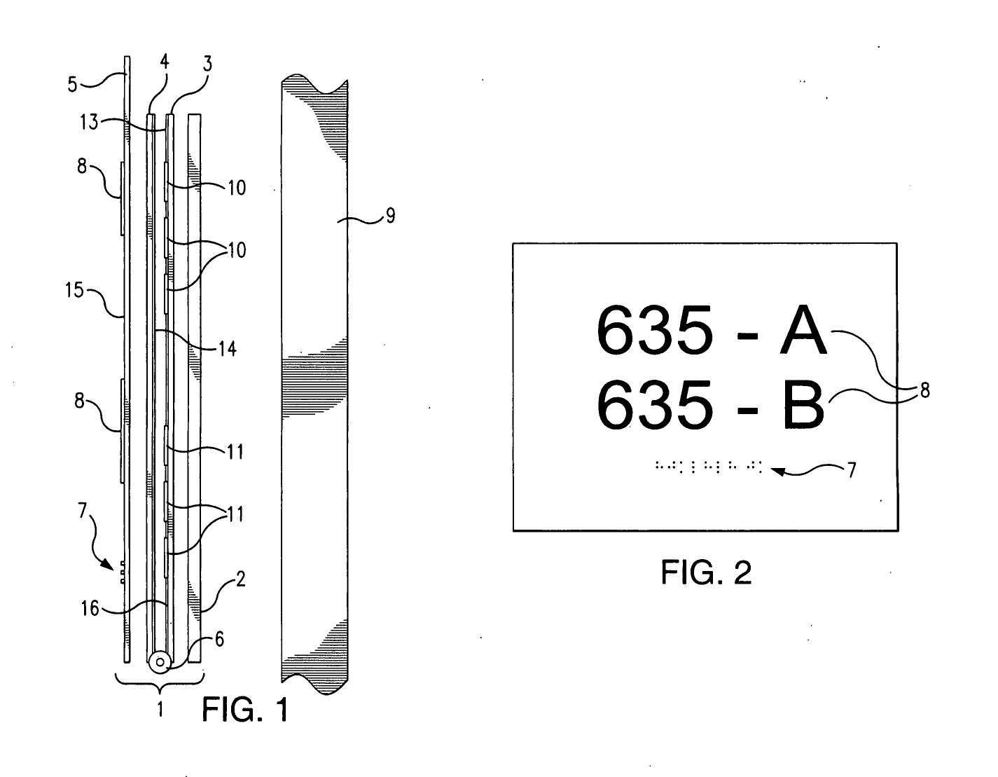

A representative example of the back surface 15 of the second base plate 4 is shown in FIG. 2, in which the room numbers, for example, are 635-A and 635-B to indicate the location of such rooms.

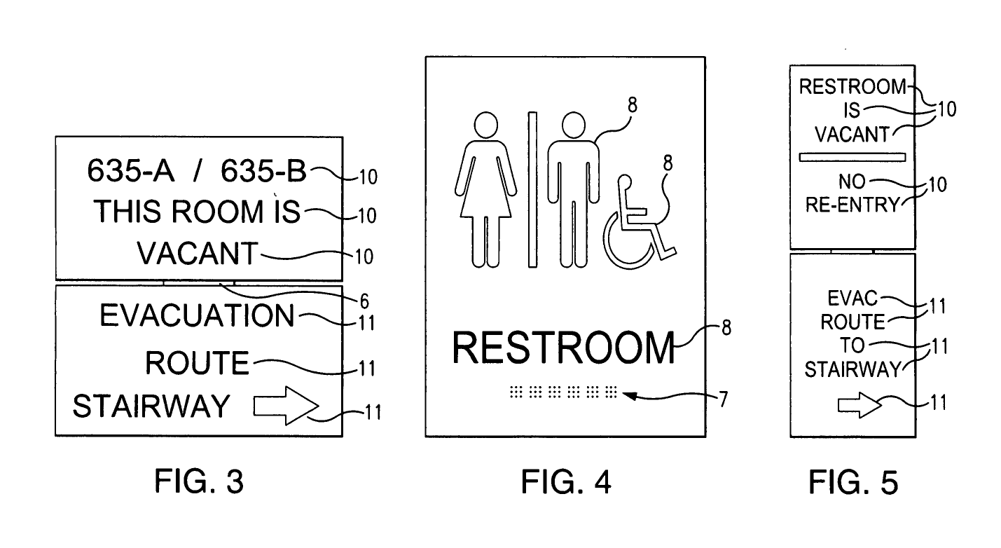

FIG. 3, shows the sign from FIG. 2 in an open position wherein the inside of the sign shows. The hinge is shown at 6. The sign has, for example, been opened by an emergency person while the building is under stress, such as fire, smoke, demolished building, to instruct that in rooms 635-A and 635-B, there is nobody in those rooms and therefore, the emergency person can go on to other rooms in the stressed building to look for other victims.

Thus, the message “635-A/635-B THIS ROOM IS VACANT EVACUATION ROUTE STAIRWAY” with an arrow is shown such that an evacuation route is made known to any person desiring to leave the stressed building.

In FIG. 4, there is shown a sign for a restroom with figures attached as thereto as indicia 8, in addition to a figure in a wheel chair (indicia 8) to show that it is a disabled accessibility restroom. At the bottom is Braille 7. FIG. 5 shows such a sign in the open position indicating that the restroom is vacant (indicia 10), there is no-re-entry (indicia 10), and an evacuation route to a stairway along with an arrow (indicia 11).

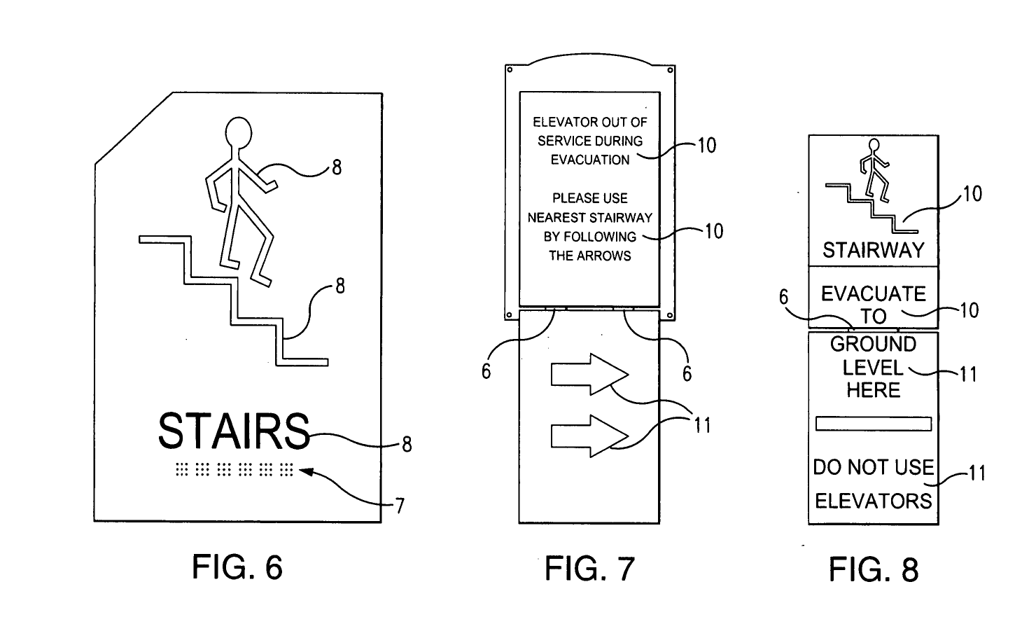

FIG. 6 shows a sign for a stairs, wherein stairs and a stick figure are used to show the stairs (indicia 8), along with the word “stairs” and Braille for the word stairs (also indicia 8). When open, FIG. 7 shows one configuration for the interior of the sign, while FIG. 8 shows another configuration for the stairs sign (all indicia 10 and 11).

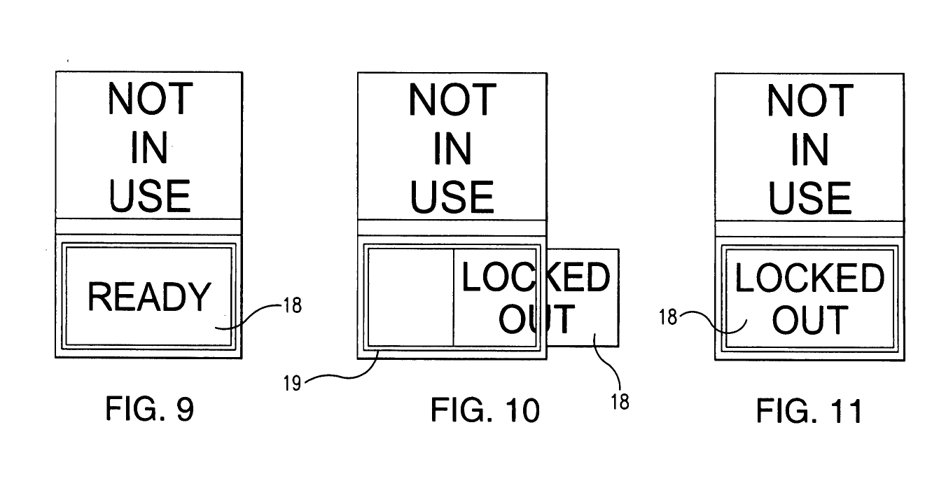

FIGS. 9, 10 and 11 illustrate an insertable sign of this invention that can be used in an industrial safety situation. FIG. 9 shows a sign indicating that a piece of equipment is ready to go by the insert 18. FIG. 11 shows the same sign with the insert 18 showing a locked out sign 18. FIG. 10 shows an insert 18 partially inserted into the insert holder 19. Such insert configurations include, for example, glassine, clear plastic and glass pockets. Also, the insert capability can be a metal frame that is open in the center, and the like.

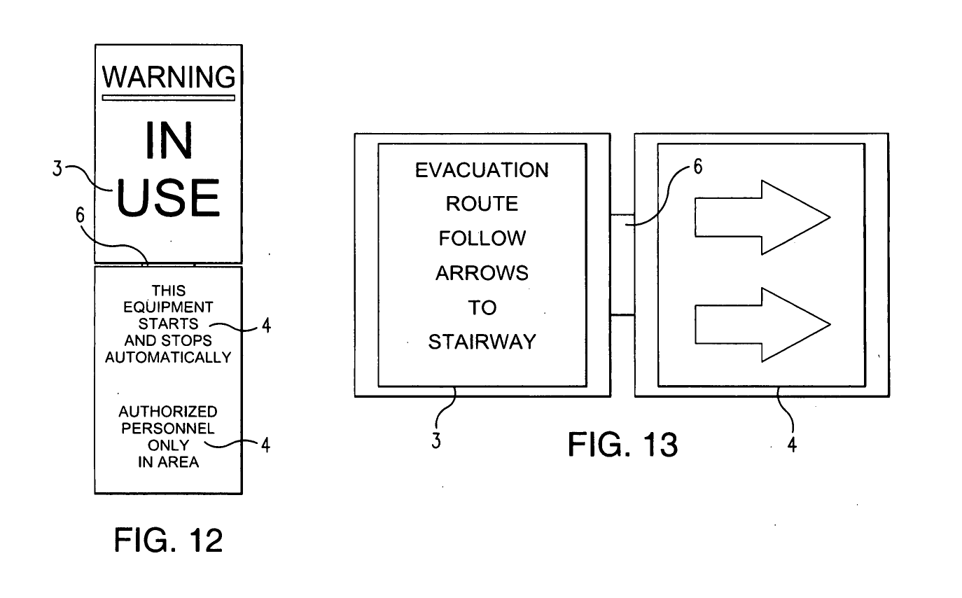

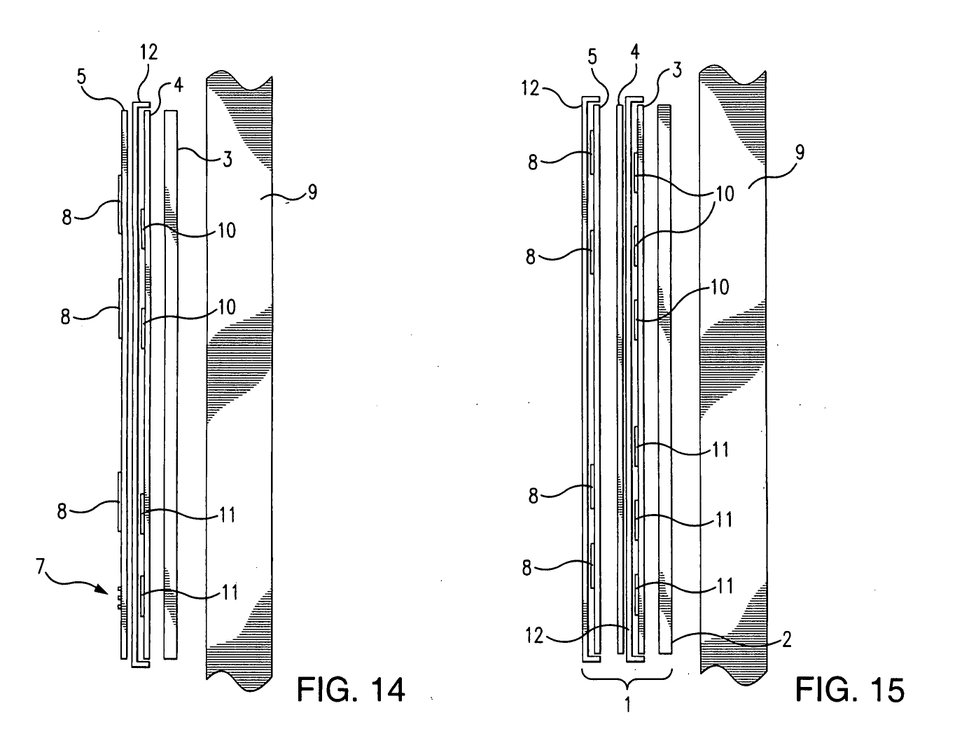

FIG. 12 shows the sign of FIGS. 9, 10, and 11 opened to show the indicia in the inside of the sign indicating that the piece of equipment is ready to go, and that the equipment starts and stops automatically.

FIG. 13 is shown to illustrate that the signs of this invention can open from top to bottom or from side to side. Turning now to FIG. 15, there is shown a full exploded side view of a sign of this invention showing the vandal panels 2 that are used to protect the indicia from vandals. Such vandal covers are known in the art and are used to prevent vandals from destroying the signs or to prevent them from rearranging the indicia on the signs. Such covers are manufactured from metal, plastic, leather, and the like.

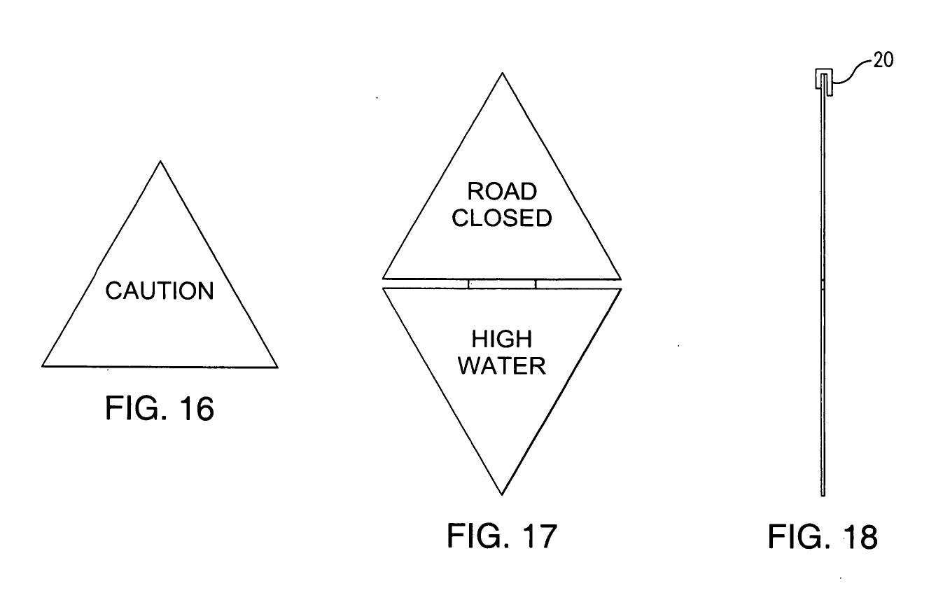

In FIGS. 16, 17, and 18, there is shown a road sign that is part of this invention. FIG. 16 shows the sign in the folded position while FIG. 17 shows the sign in an open position. In addition, FIG. 18 shows a full side view of the sign of FIG. 17, in which there is also shown a fastener 20 for the sign.

The signs of this invention can be manufactured from such materials as metal, plastic, leather, fabric, paper, cardboard, and wood, and they can be single ply, or they can be laminated structures.

It is also contemplated within the scope of this invention to employ colors in constructing the signs, wherein even the magnetic coatings can be colored.

It is further contemplated within the scope of this invention to employ reflective surfaces in the signs and it is further contemplated to manufacture signs of this invention wherein a portion of the sign employs reflective surfaces, and a portion of the sign does not.

The hinges useful in this invention can be manufactured from metal, plastic, ribbon, rope, pin type hinges, flat type hinges and it is contemplated within the scope of this invention to use hinges that have at least a 180° bend capability.

Velcro® is a registered trademark of Velcro Industries V.V. Limited Liability Company, the Netherlands.

Magnetic coatings for this invention are any type of coating material that is magnetic in nature after being placed on the surface of the sign and cured, and usually includes paints and resins as the base for such coatings.

The signs of this invention can be adhered to a surface such as a wall, or staircase, or the like using conventional means, such as nailing, screws, adhesives, and the like.

What is claimed is:

1. A non-insert magnetic sign, said sign comprising:
a. a first base plate having a bottom edge and a front surface;
b. a second base plate having a top edge and a front surface;
c. said first base plate and said second base plate each having a magnetic coating on the front surface thereof;
d. a hinge connecting the first base plate and second base plate, said hinge attached to the back surface at the bottom edge of the first base plate and attached to the front surface at the top edge of the second base plate;
e. the front surface of each base plate having at least one attachment, said attachment selected from the group consisting essentially of:
i. Letters,
ii. numbers,
iii. symbols, and,
iv. any combination of i., ii., and iii.

2. The non-insert magnetic sign as claimed in claim 1 wherein the back surface of the second base plate has a magnetic coating on it.

3. The non-insert magnetic sign as claimed in claim 2 wherein the back surface has at least one magnetic attachment.

4. The non-insert magnetic sign as claimed in claim 1 wherein, in addition, the sign is covered with a vandal cover.

5. The non-insert magnetic sign as claimed in claim 1 wherein the hinge is manufactured from plastic.

6. The non-insert magnetic sign as claimed in claim 1 wherein the hinge is manufactured from metal.

7. The non-insert magnetic sign as claimed in claim 1 wherein the hinge is manufactured from ribbon.

8. The non-insert magnetic sign as claimed in claim 1 wherein the hinge is manufactured from rope.

9. The non-insert magnetic sign as claimed in claim 1 wherein the hinge is a pin hinge.

10. The non-insert magnetic sign as claimed in claim 1 wherein the hinge is a flat hinge.

11. The non-insert magnetic sign as claimed in claim 1 wherein the hinge is a 180° bend hinge.

12. The non-insert magnetic sign as claimed in claim 1 wherein the magnetic coating is colored.

13. The non-insert magnetic sign as claimed in claim 1 wherein the magnetic coating is reflective to light.

14. The non-insert magnetic sign as claimed in claim 1 wherein the magnetic coating is non-reflective to light.

15. The non-insert magnetic sign as claimed in claim 1 wherein the sign is manufactured from metal.

16. The non-insert magnetic sign as claimed in claim 1 wherein the sign is manufactured from plastic.

17. The non-insert magnetic sign as claimed in claim 1 wherein the sign is manufactured from wood.

18. The non-insert magnetic sign as claimed in claim 1 wherein the sign has a keeper strap.

19. The non-insert magnetic sign as claimed in claim 18 wherein the keeper strap is a Velcro® strap.

20. The non-insert magnetic sign as claimed in claim 18 wherein the keeper strap is a nylon strap.

21. The non-insert magnetic sign as claimed in claim 18 wherein the keeper strap is a leather strap.

22. The non-insert magnetic sign as claimed in claim 18 wherein the keeper strap is a plastic strap.

23. The non-insert magnetic sign as claimed in claim 18 wherein the keeper strap is a metal strap.

24. The non-insert magnetic sign as claimed in claim 18 wherein the keeper strap is a fabric strap.

25. The non-insert magnetic sign as claimed in claim 18 wherein the keeper strap is a paper strap.

26. The non-insert magnetic sign as claimed in claim 18 wherein the keeper strap is a cardboard strap.

27. The non-insert magnetic sign as claimed in claim 1 wherein the sign has Braille indicia.

28. The non-insert magnetic sign as claimed in claim 2 wherein the magnetic coating is colored.

29. The non-insert magnetic sign as claimed in claim 2 wherein the magnetic coating is reflective to light.

30. The non-insert magnetic sign as claimed in claim 2 wherein the magnetic coating is non-reflective to light.

31. The non-insert magnetic sign as claimed in claim 2 wherein the sign is manufactured from metal.

32. The non-insert magnetic sign as claimed in claim 2 wherein the sign is manufactured from plastic.

33. The non-insert magnetic sign as claimed in claim 2 wherein the sign is manufactured from wood.

34. The non-insert magnetic sign as claimed in claim 2 wherein the sign has a keeper strap.

35. The non-insert magnetic sign as claimed in claim 34 wherein the keeper strap is a Velcro® strap.

36. The non-insert magnetic sign as claimed in claim 2 wherein the sign has Braille indicia.

37. A magnetic sign having insert capability, said sign comprising:
a. a first base plate having a bottom edge and a front surface;
b. a second base plate having a top edge and a front surface;
c. said first base plate and said second base plate each having a magnetic coating on the front surface thereof;
d. a hinge connecting the first base plate and second base plate, said hinge attached to the back surface at the bottom edge of the first base plate and attached to the front surface at the top edge of the second base plate;
e. the front surface of each base plate having at least one capability for an insert.

38. A magnetic sign as claimed in claim 37 wherein at least one letter is the insert.

39. A magnetic sign as claimed in claim 37 wherein at least one number is the insert.

40. A magnetic sign as claimed in claim 37 wherein at least one symbol is the insert.

41. A magnetic sign as claimed in claim 37 wherein the insert is manufactured from plastic.

42. A magnetic sign as claimed in claim 37 wherein the insert is manufactured from paper.

43. A magnetic sign as claimed in claim 37 wherein the insert is manufactured from cardboard.

44. A magnetic sign as claimed in claim 37 wherein the insert is manufactured from metal.

45. A magnetic sign as claimed in claim 37 wherein the insert is a laminated surface insert.

46. A magnetic sign as claimed in claim 37 wherein the insert is an object.

47. A magnetic sign as claimed in claim 37 wherein, in addition, the sign is covered with a vandal cover.

48. A magnetic sign, said sign comprising:
i. a base plate, said base plate having a front surface, a top portion, and a bottom portion, and a magnetic coating on the front surface;
ii. said magnetic coating having at least one magnetic attachment attached thereto, said magnetic attachment selected from the group consisting essentially of:
a. letters,
b. numbers,
c. symbols, and
d. any combination of a., b., and c.

49. A magnetic sign as claimed in claim 48 wherein, in addition, there is mounted an open window on the bottom portion.

50. A magnetic sign as claimed in claim 49 wherein there is a printed sign mounted in the open window.

51. A magnetic sign as claimed in claim 49 wherein the open window is covered by a clear plastic.

52. A magnetic sign as claimed in claim 48 wherein the sign is manufactured from metal.

53. A magnetic sign as claimed in claim 48 wherein the sign is manufactured from plastic.

54. A magnetic sign as claimed in claim 48 wherein the sign is manufactured from wood.

55. A magnetic sign as claimed in claim 48 wherein, in addition, the magnetic sign is covered with a vandal cover.

56. A non-insert sign, said sign comprising:
a. a first base plate having a bottom edge and a front surface;
b. a second base plate having a top edge and a front surface;
c. a hinge connecting the first base plate and second base plate, said hinge attached to the back surface at the bottom edge of the first base plate and attached to the front surface at the top edge of the second base plate;
d. the front surface of each base plate having at least one attachment, said attachment selected from the group consisting essentially of:
i. letters,
ii. numbers,
iii. symbols, and,
iv. any combination of i., ii., and iii, and
e. a fastener for fastening the second base plate closed over the first base plate.

57. The non-insert sign as claimed in claim 56 wherein the fastener is a clip.

58. The non-insert sign as claimed in claim 56 wherein the fastener is a snap.

59. The non-insert sign as claimed in claim 56 wherein the fastener is a lock.
